(19) United States
(12) Patent Application Publication
(10) Pub. No.: US 2014/0101004 A1
(43) Pub. Date: Apr. 10, 2014

(54) AGGREGATION OF RELATED DATA ITEMS

(71) Applicants: Tina Marseille, Walldorf (DE); Carsten Schmitt, Walldorf (DE)

(72) Inventors: Tina Marseille, Walldorf (DE); Carsten Schmitt, Walldorf (DE)

(21) Appl. No.: 13/647,102

(22) Filed: Oct. 8, 2012

(51) Int. Cl. G06Q 40/00

(52) U.S. Cl. 705/30

(57) ABSTRACT

A first data item may include data elements and be associated with a first source. A second data item may also include data elements and be associated with a second source. A determination may be made that the first data item and the second data item are related based, at least in part, on determining that a data element of the first data item matches a data element of second data item. A determination may also be made that the first source and the second source are different. The first data item and the second data item having a matching data element and different sources may then be associated with an aggregate data item.

### BACKGROUND

With rapidly expanding businesses, many employees incur various expenses in the performance of their job duties. For example, in some instances an employee may need to travel away from their employer's office as part of their job and/or incur costs during other aspects of their job function. In incurring the expenses, the employee may spend their own money, such as by charging a personal credit card, for which the employer may reimburse the employee. Such expenses may be entered as individual expense items into a travel and expense management system and/or otherwise submitted to the employer. For example, while an employee is travelling the expenses may be entered via a mobile application on a smart phone or tablet computer, the expenses may be documented textually or visually (e.g., an image of a receipt) by an e-mail or other message, or the expenses may be based upon a credit card feed. Such expense items may be added to an expense report for submission for reimbursement.

### SUMMARY

One implementation relates to a method for aggregating related expense items. The method may include receiving a first expense data item from a first source and having a first set of data elements and a second expense data item from a second source and having a second set of data elements. A determination may be made that the first expense data item and the second expense data item are related based, at least in part, on determining that one or more data elements of the first expense data item match one or more data elements of the second expense item. A determination may also be made that the first source is different from the second source. The first expense data item and the second expense data item may be associated with an aggregate expense data item.

In another implementation, a computer implemented method may include receiving a first expense data item from a first source and having a first set of data elements and a second expense data item from a second source and having a second set of data elements. A determination may be made that the first expense data item and the second expense data item are related based, at least in part, on determining that one or more data elements of the first expense data item match one or more data elements of the second expense item. A determination may also be made that the first source is different from the second source, and a notification indicating mergeable data items may be displayed.

In yet a further implementation, a tangible computer-readable medium may have instructions to receive a first expense data item from a first source and having a first set of data elements and a second expense data item from a second source and having a second set of data elements. A determination may be made that the first expense data item and the second expense data item are related based, at least in part, on determining that one or more data elements of the first expense data item match one or more data elements of the second expense item. A determination may also be made that the first source is different from the second source. An aggregate expense data item may be generated, and the first expense data item and the second expense data item may be associated with the aggregate expense data item. An aggregate expense data element may be generated based, at least in part, on the first set of data elements or the second set of data elements.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example computing device;

FIG. 2 is a block diagram of a system having a plurality of computing devices connected to a server via a network;

FIG. 3 is a flow diagram of the generation of expense items related to a transaction;

FIG. 4 is a block diagram of an example aggregate expense item having a plurality of associated expense items;

FIG. 5 is a flow diagram of an example process for generating an aggregate expense item and associating one or more related expense items;

FIG. 6 is a flow diagram of an example process for determining and merging related data items into an aggregate item;

FIG. 7A is an overview diagram of an example user interface implementing the process of FIG. 6 and showing an example notification;

FIG. 7B is an overview diagram of the example user interface of FIG. 7A showing a selection interface;

FIG. 8 is a flow diagram of an example process for grouping together and merging one or more related expense items;

FIG. 9A is an overview diagram of another example user interface implementing the process of FIG. 8 and showing a plurality of selectable expense items;

FIG. 9B is an overview diagram of the user interface of FIG. 9A showing an example grouping of one or more of the plurality of selectable expense items;

FIG. 9C is an overview diagram of the user interface of FIG. 9A showing selections of related expense items; and

FIG. 9D is an overview diagram of the user interface of FIG. 9A showing the selected expense items aggregated into aggregate expense items.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

The following is merely provided for example purposes with the explicit understanding that the examples described herein will not be used to limit the scope or the meaning of the claims.

In some instances, it may be useful to keep track of and/or manage items with an application. Such items may be manually input or may be automatically generated based on one or more sources of data for the item. For example, in the instance of an expense management application, an expense item may be manually input into the management application (e.g., by filling out a form or otherwise) or the expense item may be automatically generated based on one or more sources of data about the expense item (e.g., generation via monitoring a credit card feed, generation via monitoring an e-mailed receipt, performing optical character recognition (OCR) on a scanned receipt image, etc.). In some situations, more than one expense item may be generated for the same transaction. For example, an expense for a hotel stay may result in an e-mailed receipt, a credit card transaction, and a physical receipt. The e-mailed receipt may result in a first expense item being generated for the hotel stay. The credit card transaction may result in a second expense item being generated for the hotel stay based upon the credit card feed. The physical receipt for the stay may be scanned and an OCR operation may be performed on the image such that a third expense item is generated. Further still, a user may also manually enter expense information to generate a fourth expense item.

While it may be useful to have more than one expense item related to an expense for redundancy purposes, in some instances, it may be useful to combine the expense items into a single expense item. For example, one expense item may have information that the other expense items do not have. Thus, it may be useful to merge the information of the expense items into a single aggregate expense item such that all the information related to the expense can be found in a single expense item. The single aggregate expense item may be added to an expense report or otherwise used. In some instances, expense items may be determined to be related based upon one or more pieces of information and/or data elements of the expense items. For example, such data elements may include one or more of an amount, a date, a date range, a location, a vendor, a type, a transaction ID, etc.

By combining expense items into a single aggregate expense item, a user may avoid sorting through duplicate expense items and/or adding multiple substantially duplicate expense items to an expense report. In addition, the redundant expense items may be maintained as associated with the aggregate expense item such that the information from the redundant expense items is not deleted or otherwise lost. In some instances, a user may disassociate one or more of the expense items from the aggregate expense item (e.g., if an expense item was erroneously merged and/or otherwise). In some versions, the merging of expense items may be done only for expense items originating from different sources (e.g., merging an expense item generated from a credit card feed with one manually created, etc.). Such merging from different sources may reduce the likelihood that expense items relating to different expenses are not inadvertently merged (e.g., two expense items generated from a credit card feed may have a similar date, location, vendor, and type, but may each be for a different expense).

Of course, other implementations for merging items other than expense items may be implemented as well.

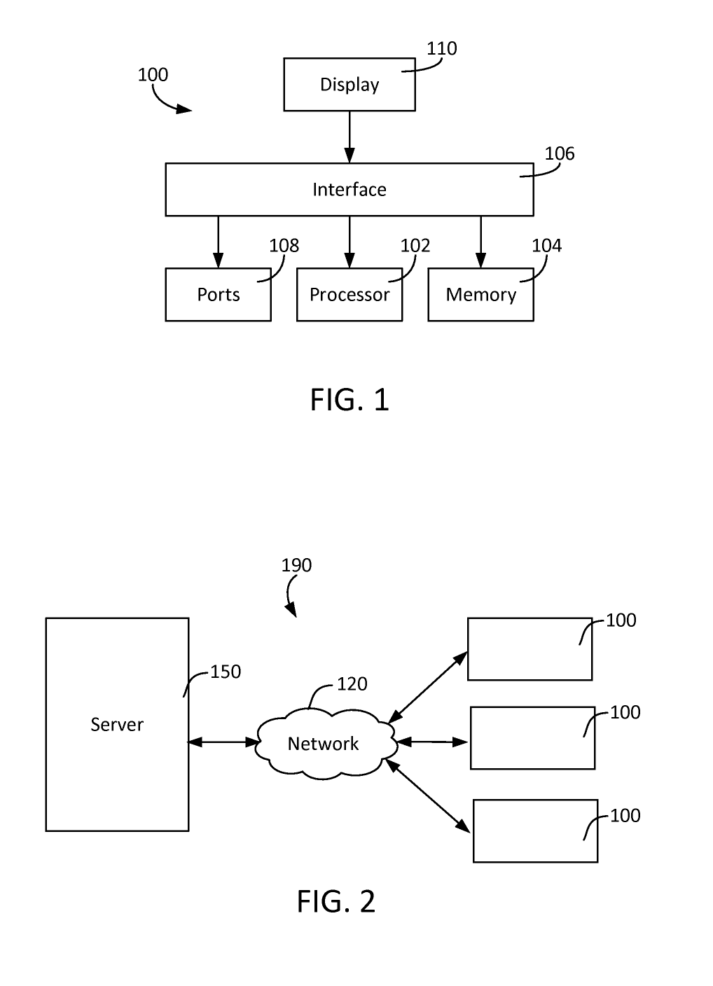

FIG. 1 is a block diagram of a computing device 100 that may be used to implement the systems and methods in accordance with the implementations described herein, as either a client or as a server or plurality of servers. Computing device 100 may include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

Computing device 100 includes a processor 102, memory 104, an interface 106 and ports 108. Each of the components 102, 104, 106, and 108, are interconnected using various busses, and may be mounted on a common motherboard or in other manners as appropriate. The processor 102 can process instructions for execution within the computing device 100, including instructions stored in the memory 104 to display graphical information for a GUI on an external input/output device, such as display 110 coupled to interface 108.

In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, a multi-processor system, etc.). The ports 108, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 102 may provide, for example, for coordination of the other components of the device 100, such as control of user interfaces, applications run by device 100, and wireless communication by device 100. Processor 102 may communicate with a user via interface 106 (e.g., control, display, external, etc.), coupled to a display 110. The display 110 may be, for example, a TFT (Thin-Film-Transistor Liquid Crystal Display) display, an OLED (Organic Light Emitting Diode) display, other flexible display, etc. The interface 106 may include circuitry for driving the display 110 to provide graphical, textual, and other information to a user. The interface 106 may receive commands (e.g., voice-activated, text, etc.), from a user and convert them to provide to the processor 102.

In addition, the interface 106 may be provided to communicate with processor 102 and enable near area communication of device 100 with other devices. The interface 106 may provide, for example, for wired communication. In some implementations, multiple interfaces may be used. Computing device 100 may communicate wirelessly through interface 106, which may include digital signal processing circuitry where necessary. Interface 106 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 100, which may be used as appropriate by applications running on device 100. The device 100 may also be provided with a storage device to provide additional storage, e.g., solid-state flash media. Each of the components may be interconnected using various buses. Several of the components may be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 comprises both volatile memory units and non-volatile memory units. The memory 104 may also be another form of computer-readable medium, such as a magnetic or optical disk. The memory 104 may be capable of providing mass storage for the computing device 100. In one implementation, the memory 104 may be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product may be tangibly embodied in an information carrier. The computer program product may also contain instructions that, when executed, perform one or more methods, such as those described below. The information carrier is a computer or machine-readable medium, such as the memory 104, memory on processor 102, a propagated signal, etc. Expansion memory may be provided and connected to device 100 through interface 106.

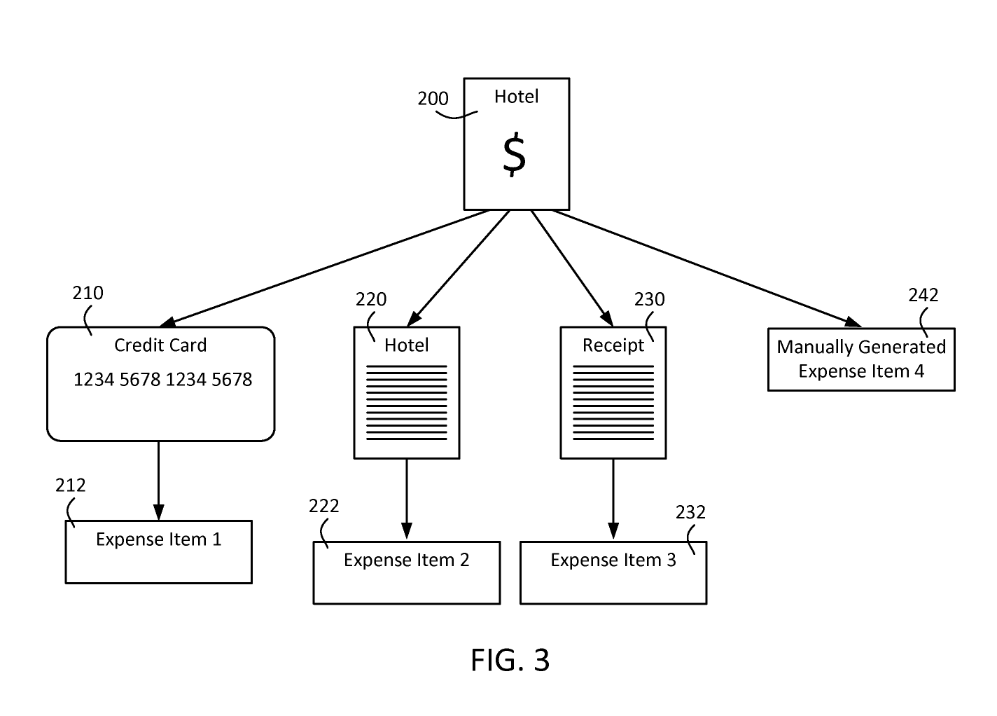

Referring to FIG. 2, in some versions, a plurality of computing devices 100 may be connected to one or more servers 150 via a network 120 to form a system 190. Network 120 may be any form of computer network that relays information between computing devices 100 and server 150. For example, network 120 may include the Internet and/or other types of data networks, such as a local area network (LAN), a wide area network (WAN), a cellular network, satellite network, or other types of data networks. Network 120 may also include any number of computing devices (e.g., computer, servers, routers, network switches, etc.) that are configured to receive and/or transmit data within network 120. Network 120 may further include any number of hardwired and/or wireless connections. For example, computing devices 100 may communicate wirelessly (e.g., via WiFi, cellular, radio, etc.) with a transceiver that is hardwired (e.g., via a fiber optic cable, a CATS cable, etc.) to other computing devices in network 120.

Server 150 may also be any number of different types of electronic devices configured to communicate via network 120 (e.g., a laptop computer, a desktop computer, a tablet computer, a smart phone, a server, combinations thereof, etc.). Server 150 may be configured in substantially the same way as computing device 100 or server 150 may have other configurations. Server 150 may include a processor and a memory, i.e., a processing circuit. The memory may store machine instructions that, when executed by the processor cause the processor to perform one or more of the operations described herein. The processor may include a microprocessor, ASIC, FPGA, etc., or combinations thereof. The memory may include, but is not limited to, electronic, optical, magnetic, or any other storage or transmission device capable of providing the processor with program instructions. The memory may include a floppy disk, CD-ROM, DVD, magnetic disk, memory chip, ROM, RAM, EEPROM, EPROM, flash memory, optical media, or any other suitable memory from which the processor can read instructions.

In some versions, system 190 may be implemented and/or integrated into an enterprise architecture. Of course, system 190 is merely and example and other systems may be used with the methods and processes described herein.

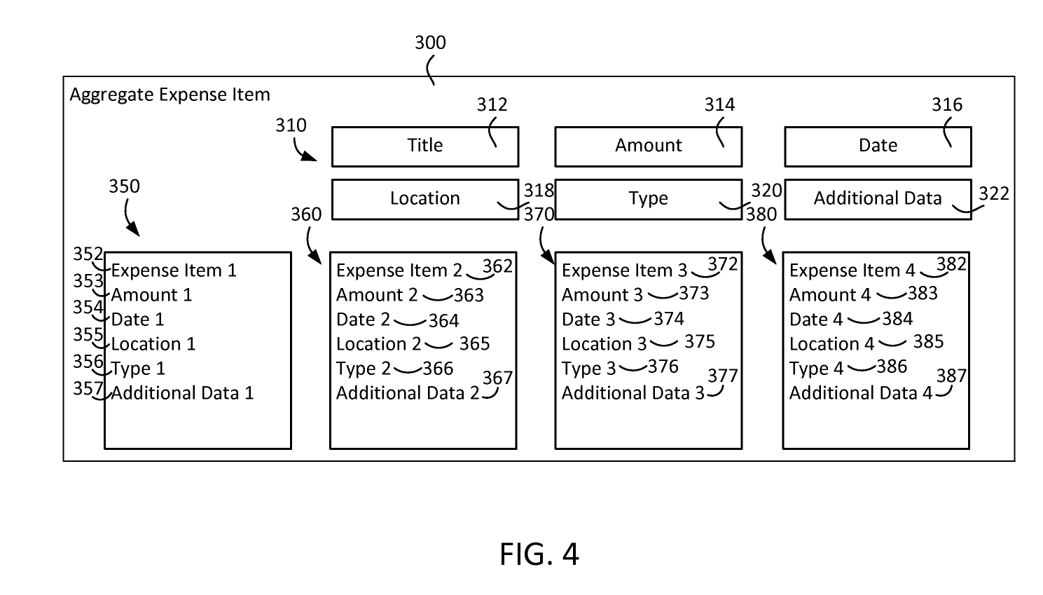

In some instances, data items relating to real world transactions may be generated automatically, semi-automatically, or manually. Referring to FIG. 3, a transaction 200 may occur and may be recorded through a number of mediums. For example, in some instances a credit card may be used, thereby resulting in a record being generated for a credit card feed 210. Credit card feed 210 may comprise one or more electronic records of transactions for a credit card. In some instances, the electronic records may include one or more pieces of information relating to the transaction. By way of example only, such information may include an amount, a date, a time, a vendor ID, a transaction ID, a location, an expense type, itemization, supplier information, and/or any other additional data. The credit card feed may be monitored such that an expense data item 212 may be generated whenever a transaction occurs in the credit card feed. The expense data item 212 may include a number of data elements that may be generated from the information about the transaction, such as an amount, a date, a time, a vendor ID, a transaction ID, a location, an expense type, itemization, supplier information, and/or any other additional data.

In some instances an electronic copy of a receipt or other recording of the transaction may be supplied to the user. For example, an e-mail containing a receipt 220 may be sent to a user. In some instances, the e-mailed receipt 220 may be parsed to extract one or more pieces of information from the e-mailed receipt 220. By way of example only, such information may include an amount, a date, a time, a vendor ID, a transaction ID, a location, an expense type, itemization, supplier information, and/or any other additional data. E-mail accounts may be monitored such that an expense data item 222 may be generated whenever an e-mail indicative of a transaction is received. The expense data item 222 may include a number of data elements that may be generated from the information of the e-mailed receipt 220, such as an amount, a date, a time, a vendor ID, a transaction ID, a location, an expense type, itemization, supplier information, and/or any other additional data.

In further instances, a physical receipt 230 may be printed and presented to a user regarding the transaction. The physical receipt 230 may include information regarding an amount, a date, a time, a vendor ID, a transaction ID, a location, an expense type, itemization, supplier information, and/or any other additional data. In some instances the physical receipt 230 may be scanned and optical character recognition (OCR) may be performed on the resulting image file to extract one or more of the foregoing items of information of physical receipt 230. Of course, other ways of generating an image file of the physical receipt 230 may be used as well, such as taking a photo of the receipt with a mobile phone or tablet. The information of the scanned physical receipt 230 may be used with a generated expense data item 232. The expense data item 232 may include a number of data elements that may be generated from the information, such as an amount, a date, a time, a vendor ID, a transaction ID, a location, an expense type, itemization, supplier information, and/or any other additional data.

In yet another instance, an expense data item 242 may be manually generated by a user. For example, a user may create a new expense data item 242 and input a number of data elements for expense data item 242. Such data elements may include a date, a time, a vendor ID, a transaction ID, a location, an expense type, itemization, supplier information, and/or any other additional data. In some implementations, a user may be able to generate new expense data items 242 via a mobile application or other application such that the user may create expense data items 242 as expenses occur. In other implementations, the user may create the expense data item 242 using a laptop computer, desktop computer, and/or via any other device having user input devices which may be used to enter data. Of course, other ways to create expense data items 212, 222, 232, 242 may be used.

While it may be useful to have multiple data items related to a transaction, in some instances it may be useful to combine the information from the various data items into a single aggregate data item. For example, a plurality of data items, such as a credit card feed receipt, a physical receipt, and an e-mailed receipt may all relate to a single transaction. It may be useful to associate the different receipts with a single aggregate data item and to incorporate the information included with each receipt with the aggregate data item while still maintaining the different receipts. Accordingly, the aggregate data item may be a single source having as much information related to a single transaction as possible from all the various receipts while still maintaining the individual receipts. For example, some data items may have information that is not included in other data items for the same transaction (e.g., an expense data item resulting from an e-mailed receipt might have itemized information while an expense data item resulting from a credit card feed may not). In some other instances, an expense report may only permit one expense data item per expense. In some instances, this may mean information may need to be transferred from the redundant expense data items and/or the redundant expense data items may need to be deleted, neither of which a user may be willing or inclined to do. In still further instances, some expense data items may not be permitted to be deleted, such as an expense data item generated from a credit card feed. Accordingly, it may be useful to create a single aggregate data item with which a number of expense data items may be associated and that has information drawn from all the underlying expense data items.

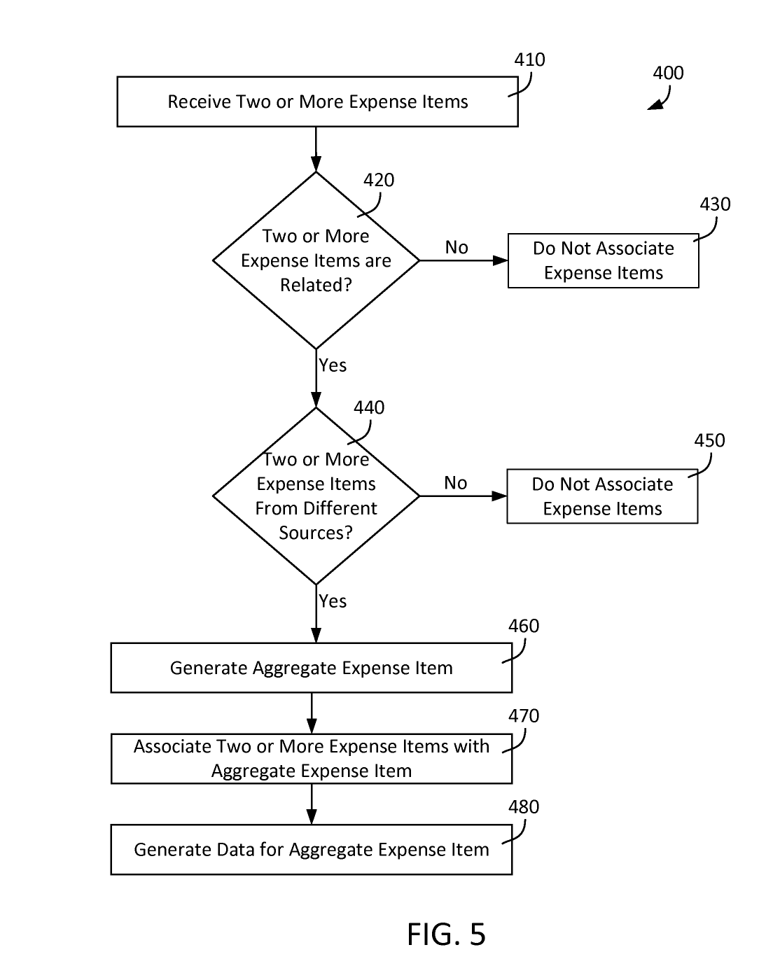

One example of such an aggregate expense date item 300 is shown in FIG. 4. As shown, aggregate expense data item 300 includes a plurality of aggregate data elements 310 and one or more associated expense data items 350, 360, 370, 380. Data elements 310 may include a title 312, an amount 314, a date 316, a location 318, a type 320, and/or any other additional data 322. Title 312 may be a user defined title generated when the aggregate expense data item 300 is created. In other versions, title 312 may be automatically generated when aggregate expense data item 300 is created and may be determined by one or more titles 352, 362, 372, 382 associated with the one or more associated expense data items 350, 360, 370, 380 and/or otherwise. Amount 314 may be a user defined amount and/or may be determined by one or more amounts 353, 363, 373, 383 associated with the one or more associated expense data items 350, 360, 370, 380. Date 316 may comprise a user-defined date and/or date range or, in some versions, date 316 may be defined based upon one or more dates 354, 364, 374, 384 of one or more expense items 350, 360, 370, 380 associated with aggregate expense data item 300. Location 318 may comprise a user-defined location or, in some versions, location 318 may be defined based upon one or more locations 355, 365, 375, 385 of one or more expense items 350, 360, 370, 380 associated with aggregate expense data item 300. Type 320 may comprise a user-defined type or, in some versions, type 320 may be defined based upon one or more types 356, 366, 376, 386 of one or more expense items 350, 360, 370, 380 associated with aggregate expense data item 300. Additional data 322 may comprise any user-defined additional data (e.g., notes, data not associated with one or more of the associated expense data items 350, 360, 370, 380, and/or otherwise) or, in some versions, additional data 322 may include any additional data 357, 367, 377, 387 of one or more expense items 350, 360, 370, 380 associated with aggregate expense data item 300. Of course, one or more of the foregoing may be omitted from aggregate expense item 300 and/or other data elements 310 may be included.

Expense data elements 350, 360, 370, 380 may each include a title 352, 362, 372, 382, an amount 353, 363, 373, 383, a date or date range 354, 364, 374, 384, a location 355, 365, 375, 385, a type 356, 366, 376, 386, and/or any additional data 357, 367, 377, 387. Of course, expense data elements 350, 360, 370, 380 each may omit one or more of the foregoing and/or may include additional information as well. For example, expense data item 350 may comprise an expense data item generated from a credit card feed and may include an amount, date, location, vendor ID, and transaction ID. Another expense data item 360 may comprise an expense data item generated from an e-mailed receipt and may include a title, an amount, a date, and a location. A third expense data item 370 may comprise an expense data item generated from a scanned physical receipt image file and may include an amount, a date, a location, and an itemization of expenses. A fourth expense data item 380 may comprise an expense data item that is manually created and may include a title, an amount, a date, a location, and a type. Thus, it should be appreciated that none of the foregoing expense data items 350, 360, 370, 380 individually includes all the information concerning the transaction.

Accordingly, it may be useful to associate the expense data items 350, 360, 370, 380 with an aggregate expense data item 300 and utilize the information from all the expense data items 350, 360, 370, 380 for the plurality of data elements of aggregate expense data item 300. Thus, a more complete record of the transaction may be provided by aggregate expense data item 300 without having a user manually re-enter data from the various expense data items related to the transaction. In addition, the underlying expense data items 350, 360, 370, 380 may be maintained for redundancy purposes with aggregate expense data item 300. Thus a user may not need to delete redundant expense data items 350, 360, 370, 380, but may associate the expense data items 350, 360, 370, 380 with an aggregate expense data item 300.

Of course, the foregoing aggregate expense data item 300 is merely an example and other aggregate data items may be utilized, including those unrelated to expenses and/or having other data. In some implementations, aggregate expense data item 300 may include other aggregate expense data items 300 as expense data items 350, 360, 370, 380. In some instances, one or more expense data items 350, 360, 370, 380 may be able to be disassociated from aggregate expense data item 300 (e.g., if an expense data item was erroneously associated and/or otherwise). In still other instances, aggregate expense data item 300 may be undone such that each expense data items 350, 360, 370, 380 is restored as an individual expense data item.

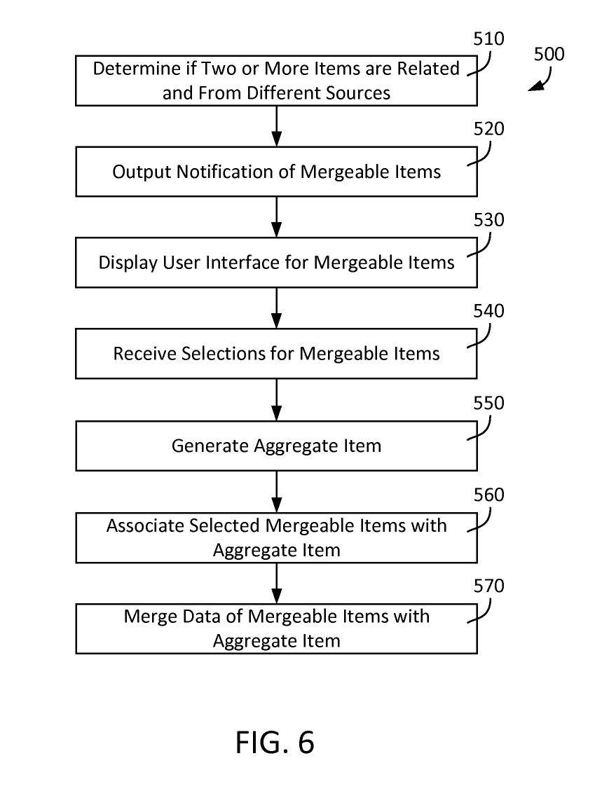

FIG. 5 depicts an example process 400 by which one or more expense data items, such as expense data items 212, 222, 232, 242, 350, 360, 370, 380, may be associated with a generated aggregate expense data item, such as aggregate expense data item 300. In some implementations, two or more expense items may be received (step 410). For example, an expense management application may include an expense buffer (e.g., a data structure having one or more expense data items that have not been assigned to an expense report object) from which two or more expense data items may be received. In other instances, two or more expense data items may be received from a database or other list of all expense items. In still another implementation, each expense data item created or generate from a source may be received as it is created or generated along with the database or other list of all expense items such that process 400 is applied to each new expense data item. Of course, the two or more expense items may be received in other ways as well.

In some implementations, a determination may be made whether the two or more expense data items are related (step 420). For example, such a determination may be based upon a comparison of one or more data elements of each expense data item to determine whether the expense data items relate to the same transaction. Some data elements that may be used in such a comparison include a title, a date, a date range, an amount, a location, an expense type, a vendor ID, a transaction ID, an itemization list, and/or any other additional data elements. In one implementation, an amount and a date may be utilized to determine whether the two or more expense items are related. For instance, a credit card feed-generated expense item may have an amount of $10.51 with a date of Feb. 1, 2012. A manually entered expense data item may also have an amount of $10.51 and a date of Feb. 1, 2012. Thus, it may be determined that the two or more expense data items are related. Other data elements may be utilized as well, for example, a date and type, a type and amount, an amount and location, a title and amount, etc.

In some versions, more than two data elements may be used to determine whether the two or more expense data items are related. For example, a date, an amount, and a location may be utilized or a date, an amount, and an expense type. Of course, other data elements may be utilized for the determination of whether the two or more expense data elements are related. If the two or more expense data items are determined to not be related, then process 400 may not associate the two or more expense data items (step 430) and may end.

If the two or more expense data items are related, then process 400 may determine whether the two or more expense data items are from different sources (step 440). By way of example only, multiple charges may be made and appear on a credit card feed. In some instances, different generated expense data items from the credit card feed may have the same or similar dates, amounts, locations, types, and/or other data elements. In such instances, two expense data elements for unrelated transactions may inadvertently be associated. In the present example, the source of the expense data items may be compared to determine that the expense data items originated from different sources. By way of example only, a data element of each expense data item may provide an indication of its source (e.g., “CC feed,” “E-Mail,” “Manual,” etc. and/or a numerical value may be associated with each type of source, such as “1” for credit card feed, “2” for e-mail, etc.). If the two or more expense data items originate from the same source, then process 400 may not associate the two or more expense data items (step 450) and may end.

Process 400 may include generating an aggregate expense item (step 460). For example, an aggregate expense data item, such as aggregate expense data item 300 shown in FIG. 4, may be created. The two or more expense data items that have been determined as being related and, optionally, as originating from different sources may be associated with the aggregate expense data item (step 470). One or more data elements associated with the aggregate expense data item may be generated based upon data from one or more associated expense data items (step 480). For example, a title, an amount, a date, a location, an expense type, and/or any other additional data may be received from the associated expense data items and may be used for one or more of the data elements associated with the aggregate expense data item. Thus, the data elements associated with the aggregate expense data item may include all the various data elements of the underlying expense data items even if some data elements are omitted from one or more expense data items, but present in another. In some instances, the resulting aggregate expense data item may thus have more information than any single expense data item associated with the aggregate expense data item.

Of course, it should be understood that one or more of the steps of process 400 may be omitted and/or other steps may be substituted, added, or otherwise.

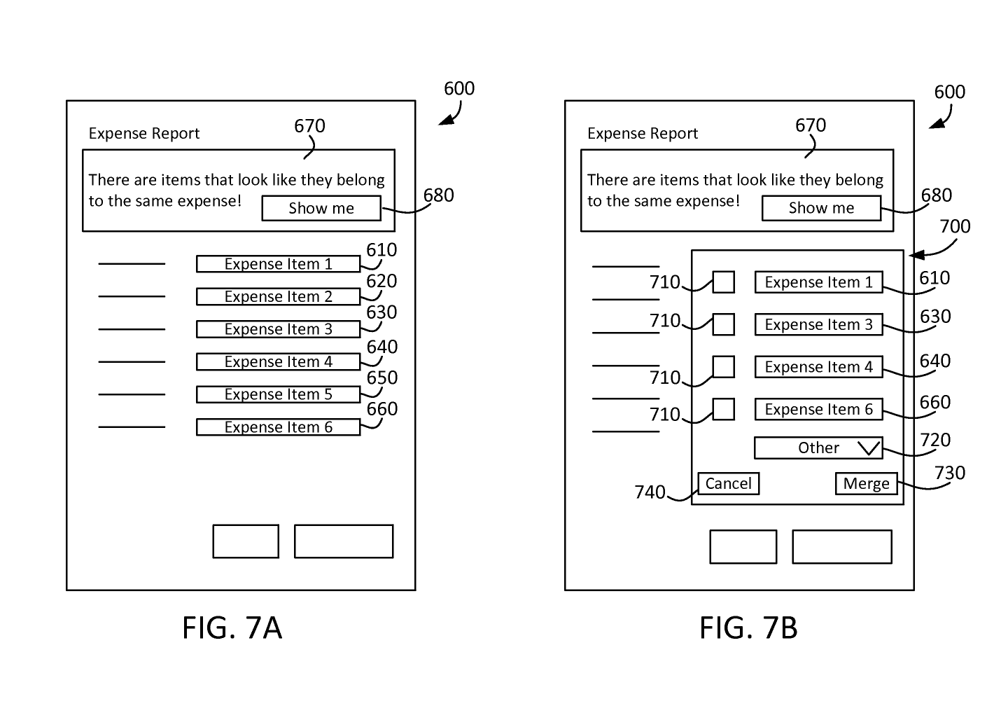

In some instances, it may be useful to incorporate the aggregation of expense data items as a feature in an expense management application. Referring to FIG. 6, an example process 500 may be utilized to provide a notification of mergeable expense data items to a user of the expense management application. Mergeable expense data items may each be different receipts related to the same transaction that, in some instances, may be useful to merge the various information together into a single expense data item. While merging the data into a single item may be useful in some instances, in others, it may be useful to create a separate item such that the different mergeable expense data items remain (e.g., as back up copies or otherwise). An aggregate expense data item may be such a separate expense data item that includes a number of mergeable expense data items. For example, an aggregate expense data item may be a separate expense data item for a single transaction, such as a hotel stay, that includes information from a number of mergeable expense data items, such as a credit card feed and an e-mailed receipt. In some implementations, a determination may be made if two or more expense data items are related and from different sources (step 510). For example, such a determination may be performed in accordance with at least some of the teachings of step 420 and/or step 440 of process 400 described herein.

In some implementations, a notification that two or more mergeable expense data items exist may be output (step 520). For example, a pop up notification, a textual notification, an icon, and/or any other notification may be output such that a user is notified that there are two or more mergeable expense data items. In some implementations, a user interface, such as user interface 600 described in greater detail below, may be presented to a user (step 530).

Utilizing a user interface, selections for mergeable expense data items may be received (step 540). In some instances, the selections of may include one or more selections of expense data items that have not been indicated as mergeable. For example, a dropdown menu of other expense data items may be provided such that a user can select one or more other expense data items to merge. It should be understood that, in some versions, the other expense data items listed in the dropdown menu may only include those expense data items resulting from sources different than a selected mergeable expense data item and/or process 500 may not merge expense data items that result from the same source.

An aggregate expense item, such as aggregate expense item 300, may be generated in response to receiving a selection of two or more mergeable expense data items and/or a selection of a mergeable expense data item and any other expense data item (step 550). The selected expense data items may be associated with the aggregate expense data item (step 560). In some implementations, one or more data elements of one or more of the selected expense data items may be used to determine one or more data elements of the aggregate expense data item (step 570) such that the data elements of the selected expense data items are merged with the aggregate expense data item.

Of course, one or more of the foregoing steps of process 500 may be omitted and/or one or more steps may be modified and/or added. For example, in some versions, the two or more mergeable expense data items may automatically be merged together without utilizing a user interface and/or receiving selections of mergeable expense data items.

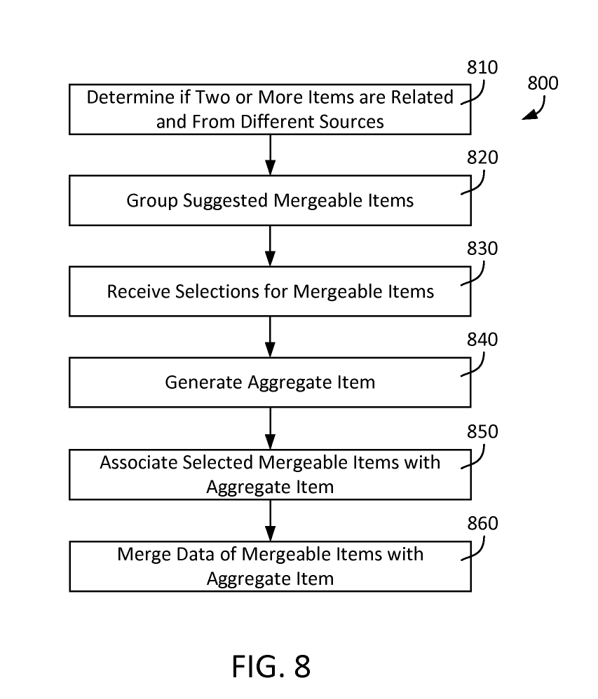

FIGS. 7A-7B depict an example user interface 600 that may be utilized to implement process 500. In the present example, user interface 600 depicts an example expense report user interface having a plurality of expense data items 610, 620, 630, 640, 650, 660 associated with the expense report. A notification portion 670 provides a textual notification to a user that two or more expense data items may be mergeable. It should be understood that notification portion 670 may appear if a pair of expense data items may be mergeable, if more than two expense data items may be mergeable, or if multiple sets of expense data items may be merged into multiple aggregate expense data items. Notification portion 670 may further include a selectable button 680 that, when selected by a user, causes a second user interface 700, shown in FIG. 7B, to be presented. In some versions, selection of selectable button 680 may automatically merge the mergeable expense data items without providing a second user interface 700. In still another version, a user may select an expense data item 610, 620, 630, 640, 650, 660 to open a detailed view of the data elements of that expense data item. In some versions, selection of the expense data item may have an option to show other expense data items that are potentially related to, and therefore mergeable with, the selected expense data item. Of course, other features and/or configurations for user interface 600 may be provided.

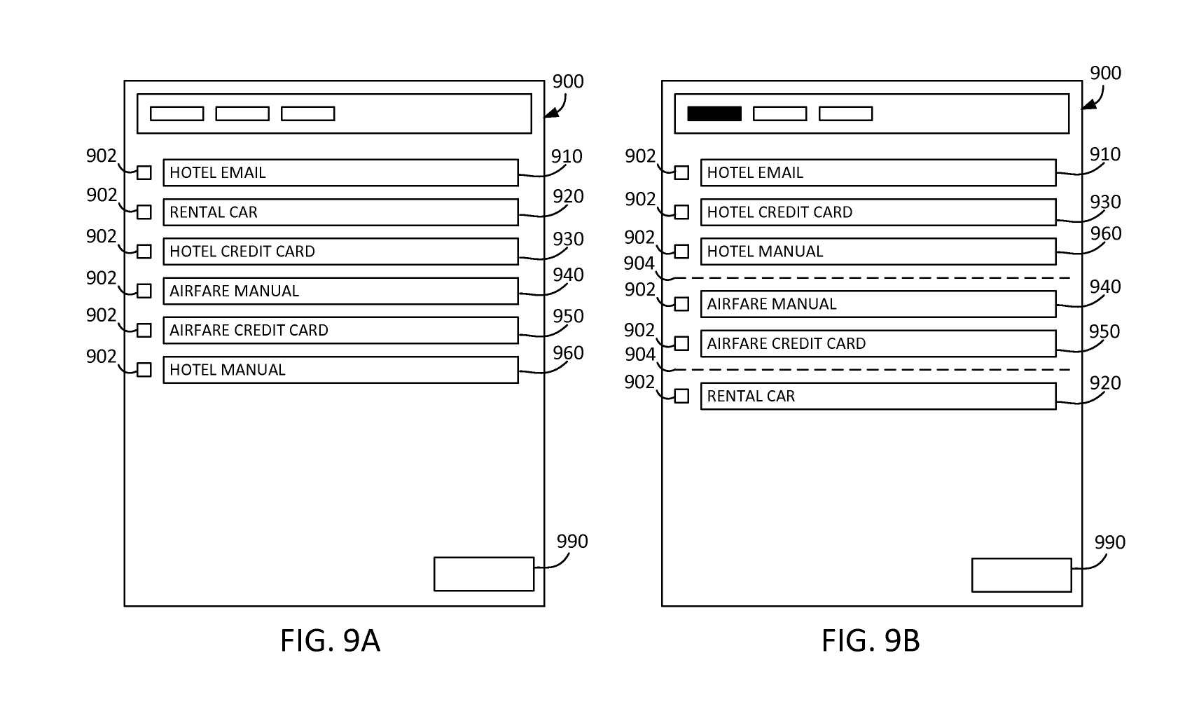

Referring now to FIG. 7B, a second user interface 700 may be presented to the user in response to a selection of selectable button 680. In the present example, second user interface 700 includes one or more suggested mergeable expense data items 610, 630, 640, 660. Suggested mergeable expense data items 610, 630, 640, 660 may be determined in accordance with step 420 and/or step 440 of process 400 described herein. Selection features 710 are provided for a user to provide one or more selections of mergeable expense data items 610, 630, 640, 660 to be merged. In some implementations, a dropdown menu of other expense data items 720 may be provided for selection of one or more other expense data items that are not presented as mergeable expense data items. For example, dropdown menu 720 may include expense data items 620, 650 and/or other expense data items. Second user interface includes a selectable merge button 730 and a selectable cancel button 740. Cancel button 740 may simply clear any selections and return the user to the view shown in FIG. 8A. Selection of merge button 730 may result in the creation of an aggregate expense data item, such as aggregate expense data item 300, association of the selected expense data items, and one or more data elements of one or more of the selected expense data items being used to determine one or more data elements of the aggregate expense data item such that the data elements of the selected expense data items are merged with the aggregate expense data item. Of course, other user interfaces 600, 700 may be utilized as well and the foregoing is merely an example.

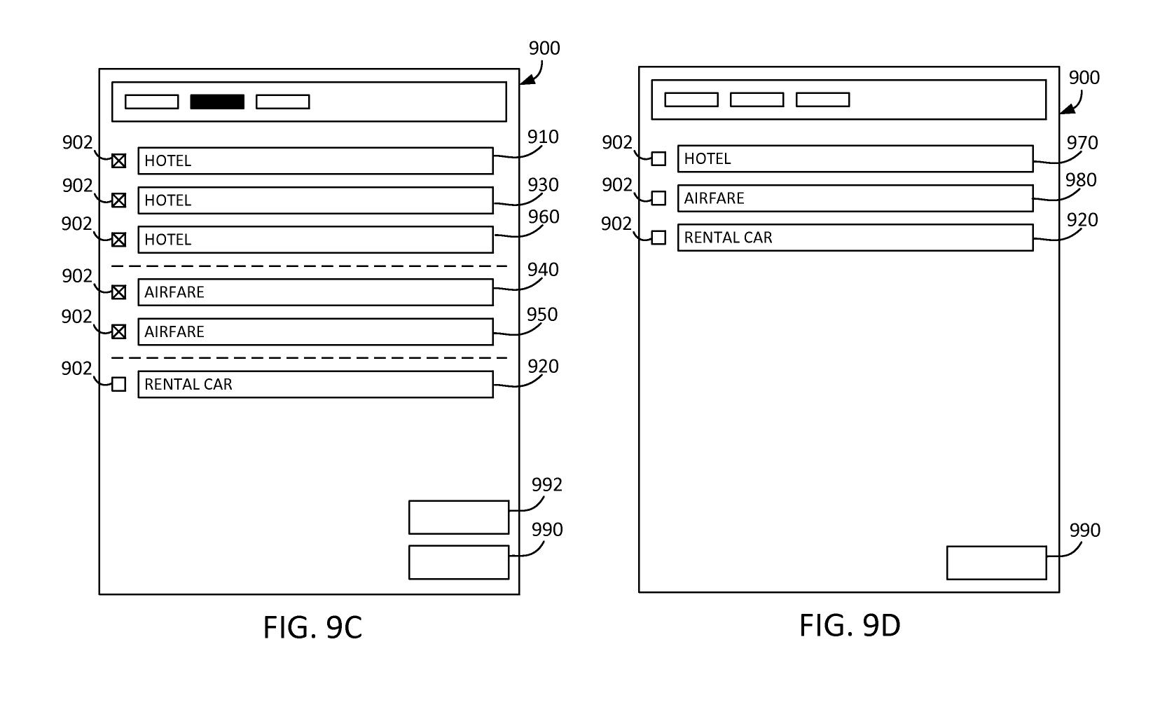

In other implementations, a list of expense data items may be presented to a user (e.g., from within an expense report, an expense buffer, or the like) and such expense data items may be sorted and grouped together if two or more expense data items are determined to be related. Referring to FIG. 8, an example process 800 may include a determination if two or more expense data items are related and from different sources (step 810). For example, such a determination may be performed in accordance with at least some of the teachings of step 420 and/or step 440 of process 400 described herein. In some implementations, the determined two or more mergeable expense data items may be sorted and grouped together (step 820). An example of such grouping is shown and described in greater detail in reference to FIGS. 9B-9C. In some implementations, one or more selections for the mergeable expense data items may be received from a user to indicate which, if any, of the mergeable expense data items should be merged together (step 830). An aggregate expense item, such as aggregate expense item 300, may be generated for each group of selected mergeable expense data items (step 840). The selected expense data items may be associated with the corresponding aggregate expense data item (step 850). In some implementations, one or more data elements of one or more of the selected expense data items may be used to determine one or more data elements of the corresponding aggregate expense data item (step 860) such that the data elements of the selected expense data items are merged with the aggregate expense data item.

Of course, one or more of the foregoing steps of process 800 may be omitted and/or one or more steps may be modified and/or added. For example, the grouping of suggested mergeable items (step 820) may be implemented with process 500 described herein.

FIGS. 9A-9D depict an example user interface 900 that may be used to implement process 800. Referring to FIG. 9A, a plurality of expense data items from a variety of sources are listed. In the example shown, the plurality of expense data items include a hotel expense data item resulting from an e-mailed receipt 910, a rental car expense data item 920, a hotel expense data item resulting from a credit card feed 930, an airfare expense data item that was manually entered 940, an airfare expense data item resulting from a credit card feed 950, and a hotel expense data item that was manually entered 960. Of course, other expense data items may be included. User interface 900 further includes one or more selection features 902 associated with a corresponding expense data item 910, 920, 930, 940, 950, 960. Selection features 902 may be used by a user to provide one or more selections of a corresponding expense data item 910, 920, 930, 940, 950, 960.

User interface 900 may further include a selectable grouping feature 990. Grouping feature 990, when selected by a user, is operable to initiate process 800. For example, initially a determination may be made of whether any of expense data items 910, 920, 930, 940, 950, 960 are related and from different sources. In the example shown, expense data items 910, 930, 960 are related to the same hotel transaction and each resulted from a different source (e.g., e-mailed receipt, credit card feed, and manually entered). Similarly, expense data items 940, 950 are related to the same airfare transaction and each resulted from a different source (e.g., manually entered and credit card feed). Expense data item 920 has no related expense data items in this example.

In accordance with process 800, expense data items 910, 930, 960 are related to the hotel transaction and are grouped together, as shown in FIG. 9B. Similarly, expense data items 940, 950 are related to the airfare transaction and are grouped together. Expense data item 920 for the rental car transaction is provided by itself. In some instances, one or more indicators 904 may be provided to indicate suggested groupings. Such indicators 904 may include dashed lines, colored highlighting, and/or any other indicator of different suggested groupings.

Referring to FIG. 9C, a user may select one or more selection features 902 to indicate which expense data items should be merged within each suggested grouping. As shown in the present example, the user has selected all of the potentially mergeable expense data items. In other instances, the user may select less than all the potentially mergeable expense data items in a suggested grouping. For example, a user may select only expense data items 910, 930 to be merged such that expense data item 960 remains as a separate expense data item.

Once a user's selections have been received for the expense data items to be merged, a selectable merge button 992 may be displayed such that the user may select the merge button 992 to create one or more aggregated expense data item and merge the selected expense data items into the aggregated expense data items. In the example shown, when the merge button 992 is selected, aggregated expense data items 970, 980 may be created and the selected expense data items 910, 930, 960, 940, 950 may be merged into aggregated expense data items 970, 980, as shown in FIG. 9D. Of course, other user interfaces 900 and/or other implementations of process 800 may be used. In some implementations, aspects of user interface 900 may be implemented into user interfaces 600, 700 and/or aspects of user interfaces 600, 700 may be implemented into user interface 900. For example, the suggested grouping aspect of user interface 900 may be included with user interface 700 described above.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor. A “machine-readable medium” and “computer-readable medium” do not include transitory signals.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for aggregating related expense data items comprising:
receiving, at a processing circuit, a first expense data item and a second expense data item, wherein the first expense data item is associated with a first source and includes a first set of one or more data elements, wherein the second expense data item is associated with a second source and includes a second set of one or more data elements;
determining, by the processing circuit, that the first expense data item and the second expense data item are related, wherein the determination is based, at least in part, on determining that one or more data elements of the first set of data elements of the first expense data item match one or more data elements of the second set of data elements of the second expense data item;
determining, by the processing circuit, that the first source associated with the first expense data item is different from the second source associated with the second expense data item; and
associating the first expense data item and the second expense data item with an aggregate expense data item.

2. The method of claim 1 further comprising:
generating an aggregate data element based, at least in part, on one or more data elements of the first set of data elements or the second set of data elements.

3. The method of claim 2, wherein the first set of data elements comprises at least one data element selected from the group consisting of a date data element, a time data element, an amount data element, a type data element, a vendor ID data element, a vendor type data element, a transaction ID data element, a location data element, an expense itemization data element, and a supplier information data element.

4. The method of claim 3, wherein the second set of data elements comprises at least one data element selected from the group consisting of a date data element, a time data element, an amount data element, a type data element, a vendor ID data element, a vendor type data element, a transaction ID data element, a location data element, an expense itemization data element, and a supplier information data element.

5. The method of claim 4, wherein the first set of data elements comprises at least two data elements and the second set of data elements comprises at least two data elements.

6. The method of claim 5, wherein the step of determining that the first expense data item and the second expense data item are related is based, at least in part, on determining that two data elements of the first set of data elements of the first expense data item match two data elements of the second set of data elements of the second expense data item.

7. The method of claim 6, wherein the two data elements of the first set of data elements of the first expense data item comprise a type data element and a date data element.

8. The method of claim 6, wherein the two data elements of the first set of data elements of the first expense data item comprise a date data element and an amount data element.

9. The method of claim 6, wherein the two data elements of the first set of data elements of the first expense data item comprise a date data element and a location data element.

10. The method of claim 6, wherein the two data elements of the first set of data elements of the first expense data item comprise an amount data element and a location data element.

11. The method of claim 4, wherein the first set of data elements comprises at least three data elements and the second set of data elements comprises at least three data elements, wherein the step of determining that the first expense data item and the second expense data item are related is based, at least in part, on determining that three data elements of the first set of data elements of the first expense data item match three data elements of the second set of data elements of the second expense data item.

12. The method of claim 2 further comprising:
generating an aggregate expense data item.

13. A computer implemented method comprising:
receiving, at a processing circuit, a first data item and a second data item, wherein the first data item is associated with a first source and includes a first set of one or more data elements, wherein the second data item is associated with a second source and includes a second set of one or more data elements;
determining, by the processing circuit, that the first data item and the second data item are related, wherein the determination is based, at least in part, on determining that one or more data elements of the first set of data elements of the first data item match one or more data elements of the second set of data elements of the second data item;
determining, by the processing circuit, that the first source associated with the first data item is different from the second source associated with the second data item; and
displaying a notification indicating mergeable data items.

14. The computer implemented method of claim 13 further comprising:
displaying a user interface comprising a first display element associated with the first data item and a second display element associated with the second data item.

15. The computer implemented method of claim 14, wherein the user interface further comprises a first selection feature associated with the first data item and a second selection feature associated with the second data item.

16. The computer implemented method of claim 15 further comprising:
grouping the first display element with the second display element.

17. The computer implemented method of claim 16 further comprising:
associating the first expense data item and the second expense data item with an aggregate expense data item; and
displaying a third display element associated with the aggregate expense data item.

18. The computer implemented method of claim 13, wherein the first data item is a first expense data item and the second data item is a second expense data item.

19. A tangible computer-readable storage medium having instructions to aggregate expense data items, the instructions comprising instructions to:
receive a first expense data item and a second expense data item, wherein the first expense data item is associated with a first source and includes a first set of one or more data elements, wherein the second expense data item is associated with a second source and includes a second set of one or more data elements;
determine that the first expense data item and the second expense data item are related, wherein the determination is based, at least in part, on determining that one or more data elements of the first set of data elements of the first expense data item match one or more data elements of the second set of data elements of the second expense data item;
determine that the first source associated with the first expense data item is different from the second source associated with the second expense data item;
generate an aggregate expense data item;
associate the first expense data item and the second expense data item with the aggregate expense data item; and
generate an aggregate data element based, at least in part, on one or more data elements of the first set of data elements or the second set of data elements.

20. The tangible computer-readable storage medium of claim 7, wherein the first set of data elements comprises at least one data element selected from the group consisting of a date data element, a time data element, an amount data element, a type data element, a vendor ID data element, a vendor type data element, a transaction ID data element, a location data element, an expense itemization data element, and a supplier information data element.
